(19) United States
(12) Patent Application Publication
(10) Pub. No.: US 2007/0277679 A1
(43) Pub. Date: Dec. 6, 2007

(54) Food serving tray having a changeable pattern

(76) Inventor: Masahide Okada, Oyama City (JP)

Correspondence Address: WENDEROTH, LIND & PONACK, L.L.P., 2033 K STREET N. W., SUITE 800, WASHINGTON, DC, 20006-1021, US

(21) Appl. No.: 11/806,583

(22) Filed: Jun. 1, 2007

(30) Foreign Application Priority Data
Jun. 6, 2006 (JP) 4247/2006

(51) Int. Cl. A47J 39/00

(52) U.S. Cl. 99/448

(57) ABSTRACT

A food serving tray having a replaceable pattern which comprises a front plate for dishing out the food and a planar bottom portion, a plurality of compartments formed in the planar bottom portion, each compartment having a transparent bottom portion, a plate having a printed pattern which is detachably put on the base of the transparent bottom portion, a frame for holding the plate in the compartment, a transparent cover put on the bottom of the compartment and a tableware groove provided longitudinally on the flange of either front plate or planar bottom portion of the food serving tray.

### BACKGROUND OF THE INVENTION

1. Field of the Invention

This invention relates to a food serving tray having a replaceable pattern in a plurality of compartments of the food serving tray, and more particularly to a food serving tray for a baby or child who can take the food or refreshments in a plurality of the compartments, each compartment having a replaceable different pattern in a bottom portion of the compartments for dishing out the food or refreshments in the tray whereby the baby or child can take a meal while enjoying the replaceable pattern during a meal.

A meal is very important for a human being to supply energy or supplement nutrition. Further, it is a matter of great important to feed a little child with a well-balanced meal during a babyhood. Such a baby meal, however, has the various problems. In other words, the baby meal is somewhat boring for the baby since it has the smell of a clay, resulting in that the little child has very poor powers of concentration, he can't stick to eating only, is likely to enter another matter, takes long time for eating, spills the meal, has too many likes and dislikes in what he eats, loses interest in meal, and sometimes stops eating during the meal.

In this way, it is very important to concentrate the baby's attention to his meal so that it needs to attract the baby's interest in the meal.

Under the conventional food serving tray, the desired design or pattern of the food is printed on the bottom of the food serving tray for a diabetic in order to show the required food.

2. Background of the Technology

The Japanese Utility Model Publication No. 24324/1995 (Yoshio Beppu), (Patent Literature No. 1) relates to the food serving tray which is mainly used for a dietetic treatment such as diabetes, etc. The conventional food serving tray, however, has the following disadvantage that even though some effect can be observed at the beginning, the printed design or pattern of the given character is left as it is, and a baby or small child gets tired soon of the same design or pattern, thus losing his pleasure what design or pattern will come up after eating and losing the concentration to the meal as well.
U.S. Pat. No. 6,129,235 (Creske) discloses a party tray which the user can hold in either hand.
U.S. Pat. No. 6,440,509 (Littlejohn et al.) discloses a compartmented disposable plate with asymmetric rib geometry.

### SUMMARY AND OBJECTS OF THE INVENTION

A principal aspect of this invention is to provide a food serving tray having a replaceable pattern which comprises a front plate for dishing out the food or refreshments, a planar bottom portion, a plurality of compartments formed in the planar bottom portion, each compartment having a transparent bottom portion, a plate having a given printed pattern which is detachably put on the base of the transparent bottom portion, a frame having substantially the same size as the compartment for holding the plate in the compartment whereby the plate having the printed pattern can be manually replaced for another one which can be easily seen from the surface of the food serving tray in order to attract an eater's interest in a meal.

Another aspect of this invention is to provide a food serving tray having a replaceable pattern which comprises a front plate for dishing out the food or refreshments, a planar bottom portion, a plurality of compartments formed in the planar bottom portion, each compartment having a transparent bottom portion, a plate having a given printed pattern which is detachably put on the base of the transparent bottom portion, a frame having substantially the same size as the compartment for holding the plate in the compartment, and a tableware groove provided longitudinally on the flange of the front plate for storing chopsticks, a spoon, a fork, a knife, etc. whereby the plate having the printed pattern can be manually replaced for another one which can be easily seen from the surface of the food serving tray in order to attract an eater's interest in a meal,

Another aspect of this invention is to provide a food serving tray having a replaceable pattern which comprises a front plate for dishing out the food or refreshments, a planar bottom portion, a plurality of compartments formed in the planar bottom portion, each compartment having a transparent bottom portion, a plate having a given printed pattern which is detachably put on the base of the transparent bottom portion, a frame having substantially the same size as the compartment for holding the plate in the compartment, a transparent cover having substantially the same size as the compartment and put on the bottom of the compartment, a tableware groove provided longitudinally on the flange of the bottom portion of the food serving tray for storing chopsticks, a spoon, a fork, a knife, etc. and a lid provided pivotally on the bottom flange adjacent to the tableware groove which works as a support for supporting the food serving tray for ornamental purpose.

Another aspect of this invention is to provide a food serving tray having a replaceable pattern which comprises a front plate for dishing out the food or refreshments, a planar bottom portion, a substantially rectangular box including a sidewall and a flange, a plurality of compartments in the food serving tray whereby the food or refreshments can be easily dished out in the compartments.

Another aspect of this invention is to provide a food serving tray having a replaceable pattern which comprises a front plate for dishing out the food or refreshments and a substantially rectangular box including a sidewall and a flange, a plurality of compartments in the food serving tray whereby the pattern showing the desired pattern in each compartment can be manually and easily replaced with another one.

Still another aspect of this invention is to provide a food serving tray which comprises a front plate for dishing out the food or refreshments, a planar bottom portion, a substantially rectangular box including a sidewall and a flange, a plurality of compartments in the food serving tray for use with serving the food or refreshments to a baby or a child whereby he can taste not only a meal, but also enjoy the replaceable patterns.

### BEST MODE OF CARRYING OUT THE INVENTION

The essential feature of this invention is to provide a food serving tray which comprises a substantially rectangular box including a sidewall and a flange, a plurality of compartments in the food serving tray for dishing out the food or refreshments, each compartment having a transparent bottom portion, a plate having a given printed pattern detachably put on the base of the transparent bottom portion, and a transparent cover put on the food serving tray whereby the printed pattern can be easily seen from the surface of the food serving tray in order to attract an eater's interest in the meal.

These and other advantages of the invention will become more apparent from the following detailed description thereof when taken in conjunction with the accompanying drawings.

### BRIEF EXPLANATION OF THE DRAWINGS

FIG. 1 is a schematically front perspective view of an embodiment of a food serving tray for dishing out the food or refreshments of this invention.

FIG. 2 is a schematically back perspective view of an embodiment of a food serving tray for dishing out the food or refreshments, from which

FIG. 3 is an enlarged sectional view of the a food serving tray shown in FIG. 1, taken along a line 111-111.

FIG. 4 is a schematically back perspective view of another embodiment of a food serving tray for dishing out the food or refreshments.

### DETAILED DESCRIPTION OF THE PREFERRED EMBODIMENT

Referring to the accompanying drawings, in which like numerals designate like parts throughout the several views thereof, this invention will be explained with respect to an embodiment.

### EXAMPLE 1

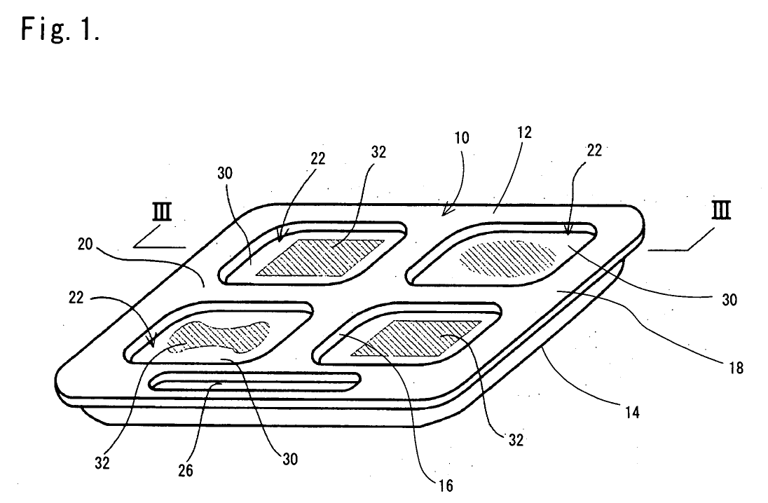

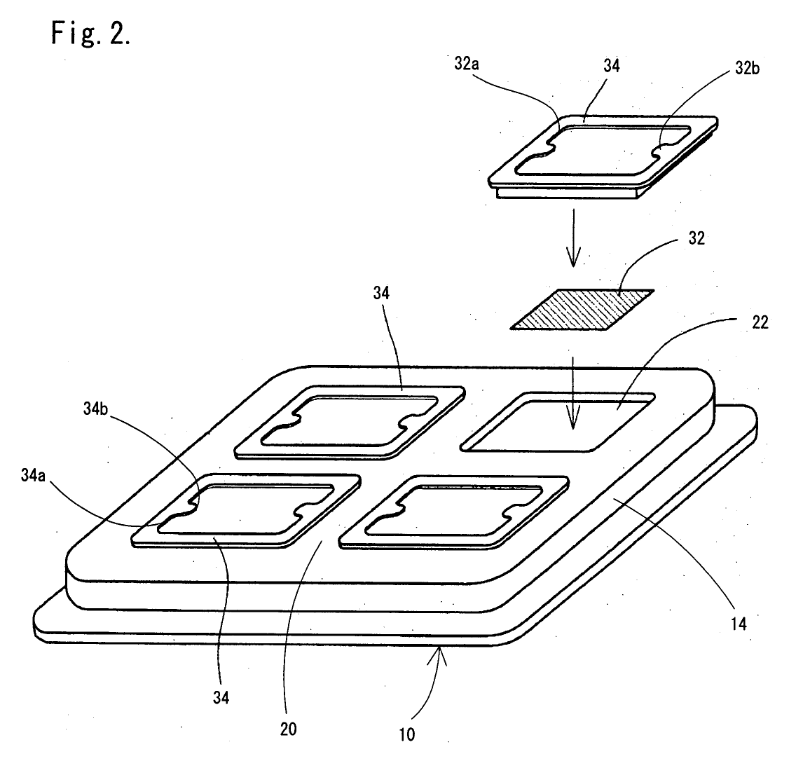

An embodiment of a food serving tray 10 having a replaceable pattern for use with a meal for a baby or child of this invention is explained with reference to FIGS. 1˜3, and as particularly shown in FIG. 2, the food serving tray 10 described in claim 1 is a substantially rectangular box includes a front plate 12 and a planar bottom portion 14, a sidewall 16 and a flange 18.

Provided on a surface of the food serving tray 10 are a plurality of rectangular compartments 22, 22 . . . which are defined by a plurality of partitions 20, 20 . . . , thus forming a crossed-ditch 24 on the planar bottom portion 14 of the food serving tray 10 and also enabling to dish out the food or refreshments in the compartments 22, 22 . . . .

It should be noted that the bottom portion of each compartment 22 is transparent, a plate 32 having a given printed pattern P is detachably put on the base of the transparent bottom portion 30.

### EXAMPLE 2

With reference to the food serving tray 10 described in claim 2, a plate 32 has a substantially the same size as that of the transparent bottom portion 30, and a pair of opposing projections 34b, 34b are provided at a middle position of opposite sides 34a, 34a respectively, which are fitted into the compartment 22 to hold the plate 32.

A tableware groove 26 is formed longitudinally on a surface of the flange 18 of the food serving tray 10 in order to store chopsticks, a spoon, a fork, a knife, etc.

### EXAMPLE 3

As shown in FIG. 2, a plate 32 has a substantially the same size as that of the transparent bottom portion 30, and a pair of opposing projections 34b, 34b are provided at a middle position of the sides 34a, 34a of a frame 34 so that the frame 34 thus fitted into the compartment 22 can hold the plate 32 in the compartment 22 in order to show the desired design or pattern P in the compartment 22 from the surface of the food serving tray 10.

### EXAMPLE 4

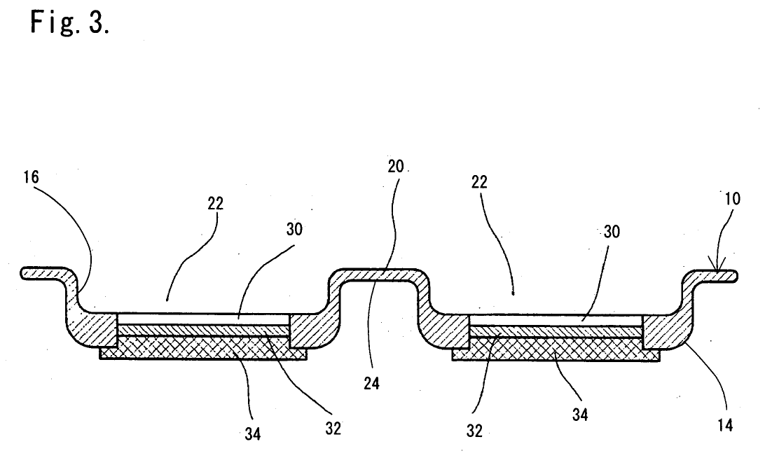

In another embodiment, FIGS. 1, 3 and 4, a food serving tray 10 described in claim 3 comprises a substantially rectangular box, a planar bottom portion 14, a sidewall 16, a flange 18, a plurality of rectangular compartments 22, 22 . . . which are defined by a plurality of partitions 20, 20 . . . , thus forming a crossed-ditch 24 on the planar bottom portion 14 of the food serving tray 10 and also enabling to dish out the food or refreshments in the compartments 22, 22 . . . .

### EXAMPLE 5

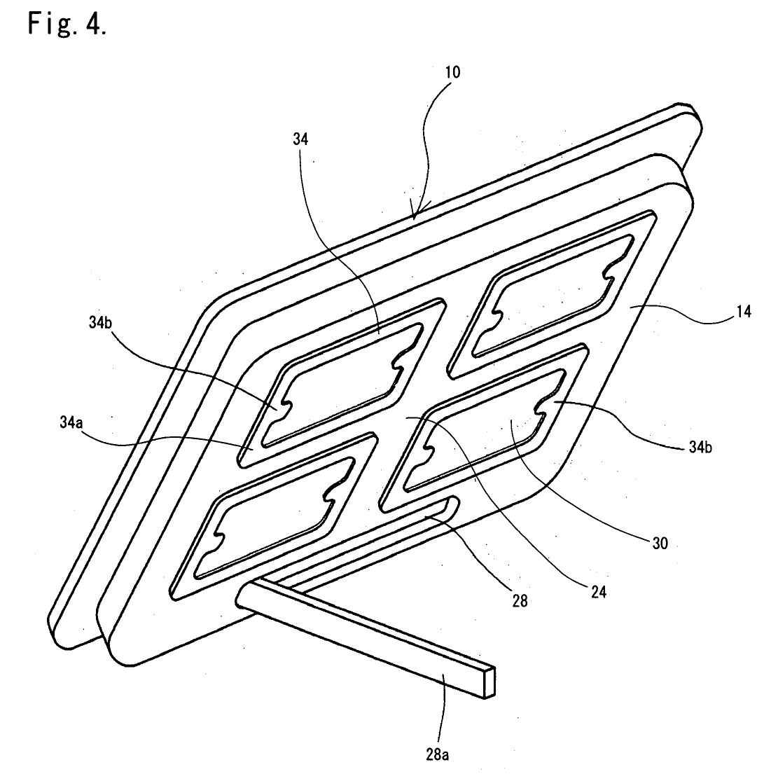

As shown in FIG. 4, a food serving tray 10 described in claim 4 comprises a substantially rectangular box, a planar bottom portion 14, a sidewall 16, a flange 18, a plurality of rectangular compartments 22, 22 . . . which are defined by a plurality of partitions 20, 20 . . . , and a tableware groove 28 is formed longitudinally on the flange 18 of the planar bottom portion 14 and a lid 28a is pivotally mounted on the bottom of the flange 18 adjacent thereto, thus enabling to store chopsticks, a spoon, a fork, a knife, etc. in the bottom tableware groove 28 and also working the lid 28a to support the food serving tray 10 for ornamental purpose.

As explained in the foregoing paragraphs, the plate 30 having the given printed pattern P can be manually replaced with another plate 30 having another printed pattern P, thus attracting the baby's interest in the meal.

Although this invention has been fully described by way of examples with reference to the accompanying drawings, it is to be noted that various changes and modifications will be apparent to those skilled in the art. Therefore, unless otherwise such changes and modifications depart from the scope of this invention, they should be construed as being included therein.

1. A food serving tray having a replaceable pattern which comprises:
a front plate for dishing out the food or refreshments,
a planar bottom portion and a plurality of compartments formed in the planar bottom portion, each compartment having a transparent bottom portion,
a plate having a given printed pattern which is detachably put on the base of the transparent bottom portion,
a frame having substantially the same size as the compartment for holding the late in the compartment,
whereby the plate having the printed pattern can be manually replaced for another one which can be easily seen from the surface of the food serving tray in order to attract an eater's interest in a meal.

2. A food serving tray according to claim 1, wherein a tableware groove is formed longitudinally on the flange for storing chopsticks, a spoon, a fork, a knife, etc.

3. A food serving tray according to claim 1, wherein a tableware groove is provided longitudinally on the bottom portion of the food serving tray and a lid is provided pivotally on the bottom portion adjacent to the tableware groove whereby the lid works to support the food serving tray for ornamental purpose.

4. A food serving tray according to claim 1, wherein the frame has a pair of opposing projections at a middle position of a side of the frame for holding the plate having the printed pattern in the bottom of the compartment respectively.

5. A food serving tray according to claim 2, wherein the frame has a pair of opposing projections at a middle position of a side of the frame for holding the plate having the printed pattern in the bottom of the compartment respectively.

6. A food serving tray according to claim 3, wherein the frame has a pair of opposing projections at a middle position of a side of the frame for holding the plate having the printed pattern in the bottom of the compartment respectively.
